(19) United States
(12) Patent Application Publication
(10) Pub. No.: US 2025/0212036 A1
(43) Pub. Date: Jun. 26, 2025

(54) JOINT-REPEATER-UE BEAM REPORT IN REPEATER-ASSISTED NETWORKS

(71) Applicant: Telefonaktiebolaget LM Ericsson (publ), Stockholm (SE)

(72) Inventors: Andreas Nilsson, GÖTEBORG (SE); Magnus Åström, Lund (SE); Boris Dortschy, Vendelsö (SE); Behrooz Makki, PIXBO (SE); Lei Bao, GÖTEBORG (SE)

(73) Assignee: Telefonaktiebolaget LM Ericsson (publ), Stockholm (SE)

(21) Appl. No.: 18/848,931

(22) PCT Filed: Apr. 21, 2023
(86) PCT No.: PCT/EP2023/060538

§ 371 Date: Sep. 20, 2024

Related U.S. Application Data
(60) Provisional application No. 63/334,363, filed on Apr. 25, 2022.

(51) Int. Cl. H04W 24/10; H04B 7/06; H04B 7/145; H04B 17/318

(52) U.S. Cl. CPC H04W 24/10; H04B 7/0696; H04B 7/06964; H04B 7/145; H04B 17/328

(57) ABSTRACT

Systems and methods for joint-repeater-UE beam reporting in repeater-assisted networks are provided. In some embodiments, a method performed by a wireless network node for monitoring a connection to a UE through a repeater node includes: configuring the UE with one or more beam reports containing reference signals for evaluating one or more links between one or more of the group consisting of: the wireless network node, the repeater, and the UE; triggering one or more of the configured beam reports; transmitting one or more configured reference signals associated with the triggered beam reports; and receiving the one or more beam reports. In this way, overhead-efficient methods are provided for radio link monitoring in the presence of a repeater node to activate the beam and/or link recovery process.

### TECHNICAL FIELD

The current disclosure relates generally to managing a repeater node.

### BACKGROUND

### Network Controlled Repeater

To increase the data rate and support the increasing number of UEs, different methods are considered, among which network densification and millimeter wave (mmW) communications are the dominant ones. Network densification refers to the deployment of multiple access points of different types in, e.g., metropolitan areas. Particularly, it is expected that in future small nodes, such as relays, IABs, repeaters, etc., will be densely deployed to support existing macro base stations (BS) serving UEs.

During the 3GPP Rel-16 and Rel-17, Integrated Access and Backhaul (IAB) has been well studied as the main relaying technique in 5G, and the discussions will continue in Rel-18 on Mobile IAB. Here, using decode-and-forward relaying technique, the IAB can well extend the coverage and/or increase the throughput. However, IAB may be a relatively complex and expensive node and thereby, depending on the deployment, we may require alternative nodes with low complexity/cost for, e.g., blind spot removal. Here, a candidate type of network node is the Radio Frequency (RF) repeaters which simply amplify-and-forward any signal that they receive. RF repeaters have been considered in 2G, 3G, and 4G to supplement the coverage provided by regular full-stack cells. However, RF repeater lacks in, e.g., accurate beamforming which may limit its efficiency in, for instance, FR2.

With this background, a new study-item has been considered in 3GPP Rel-18, to start in early 2022, in which the potentials and the challenges of Network-Controlled Repeaters (NCR) will be evaluated. The scope and the features of network-controlled repeater are still under discussion. FIG. 1 gives an example of an NCR node deployment where the wireless connection between the NCR node and the gNB is referred to as service link, whereas the wireless connection between the NCR node and the UE is referred to as access link. In some embodiments, the service link comprises a control link and a backhaul link.

In one alternative, a network-controlled repeater can be a normal repeater with beamforming capabilities. In this way, the NCR node should be considered as a network-controlled “beam bender” relative to the gNB. As such, it is logically part of the gNB for all management purposes, i.e., it is likely that the network-controlled repeater is deployed and under the control of the operator. Network-controlled repeater is based on amplify-and-forward relaying scheme, and it is likely to be limited to single-hop communication in stationary deployments with the focus on FR2. Finally, the scope of the Rel-18 study-item is expected to be strictly on studying the PHY control signaling and mechanism and, consequently, the study-item will be carried out mainly by RAN1.

In particular, the Network-Controlled Repeater (NCR) Study Item Description (SID) considers the following as focus for the study-item:
Network-controlled repeaters are inband RF repeaters used for extension of network coverage on FR1 and FR2 bands, while during the study FR2 deployments may be prioritized for both outdoor and O2I scenarios.
For only single hop stationary network-controlled repeaters
Network-controlled repeaters are transparent to UEs
Network-controlled repeater can maintain the gNB-repeater link and repeater-UE link simultaneously

Also, the NCR SID will concentrate on identifying which side control information is required regarding:
Beamforming information
Timing information to align transmission/reception boundaries of network-controlled repeater
Information on UL-DL TDD configuration
Power control information for efficient interference management.
ON-OFF information for efficient interference management and improved energy efficiency

How a network-controlled repeater will be designed and how it will communicate with the network is still not clear. FIG. 2 illustrates one schematic example of how an NCR can be implemented. In this example, the network-controlled repeater consists of three principal building blocks, the Modem, the Controller module, and the Repeater module section (depicted as the two amplifiers in FIG. 2). The network-controlled repeater is equipped with an antenna configuration, where a signal is first received in downlink (or uplink), and, e.g., after power amplification, transmitted further in downlink (or uplink). Since the Repeater module only amplifies and (analogously) beamforms the signal, no advanced receiver or transmitter chains are required, which reduces the cost and energy consumption compared to for example a normal Transmission and Reception Point (TRP). In its simplest architecture, different antenna modules are used for the service and access sides, i.e., the antennas targeting the gNB and UEs, respectively, whereas a more complex architecture, including self-interference cancellation, would allow for using the same antenna modules for both sides.

The Modem module is able and used to exchange control and status signaling with a gNB that is controlling the network-controlled repeater. For this, the Modem module supports at least a sub-set of UE functions. Network-controlled repeater control and status information is further exchanged between the Modem module and the Controller module. The Modem module might be equipped with antennae separated from the antennae used by the Repeater module; but in most configurations, the Modem module and Repeater module will share antenna configurations.

The Controller module is used to control the Repeater module, by for example providing beamforming information, power control information etc. The Controller module is connected to the network through the Modem module such that the network can control the Controller module and, in that way, control the Repeater module.

The Repeater modules amplify-and-forward operation is controlled by the Controller module. The Controller module could also be directly responsible for the beamforming control on the service antenna side, i.e., to/from served UEs. In an alternative, the beamforming on the service antenna side is operated by the Repeater module under control of the Controller module. On the access antenna side, i.e., to/from the controlling gNB, the Modem module could be directly responsible for the beamforming control. In an alternative, the beamforming on the access antenna side is operated by the Repeater module under control of the Controller module and/or Modem module.

In one configuration, the Modem module and the Repeater module do not only share an antenna configuration but also parts of the (analog) transmitter and/or receiver, such as power (transmit) amplifier and/or receiver amplifiers and/or filters.

The Modem module and the Repeater module could be operating at the same or different frequencies. For example, the Repeater module could operate at a high frequency band (FR2) and the Modem module could be operating at a low frequency band (FR1)

### NR Multi-Beam Operation

### Beam Management Procedure

In high frequency range (e.g., Frequency Range 2 (FR2)), multiple RF beams may be used to transmit and receive signals at a gNB and a UE. For each DL beam from a gNB, there is typically an associated best UE Rx beam for receiving signals from the DL beam. The DL beam and the associated UE Rx beam form a beam pair. The beam pair can be identified through a so-called beam management process in NR.

A DL beam is (typically) identified by an associated DL reference signal (RS) transmitted in the beam, either periodically, semi-persistently, or aperiodically. The DL RS for the purpose can be a Synchronization Signal (SS) and Physical Broadcast Channel (PBCH) block (SSB) or a Channel State Information RS (CSI-RS). By measuring all the DL RSs, the UE can determine and report to the gNB the best DL beam to use for DL transmissions. The gNB can then transmit a burst of different Downlink Reference Signals (DL-RSs) in the reported best DL beam to let the UE evaluate candidate UE RX beams.

Although not explicitly stated in the NR specification, beam management has been divided into three procedures, schematically illustrated in FIG. 3:

P-1: Purpose is to find a coarse direction for the UE using wide gNB TX beam covering the whole angular sector

P-2: Purpose is to refine the gNB TX beam by doing a new beam search around the coarse direction found in P-1.

P-3: Used for UE that has analog beamforming to let them find a suitable UE RX beam.

P-1 is expected to utilize beams with rather large beamwidths and where the beam reference signals are transmitted periodically and are shared between all UEs of the cell. Typically reference signal to use for P-1 are periodic CSI-RS or SSB. The UE then reports the N best beams to the gNB and their corresponding RSRP values.

P-2 is expected to use aperiodic/or semi-persistent CSI-RS transmitted in narrow beams around the coarse direction found in P-1.

P-3 is expected to use aperiodic/or semi-persistent CSI-RSs repeatedly transmitted in one narrow gNB beam. One alternative way is to let the UE determine a suitable UE RX beam based on the periodic SSB transmission. Since each SSB consists of four OFDM symbols, a maximum of four UE RX beams can be evaluated during each SSB burst transmission. One benefit of using SSB instead of CSI-RS is that no extra overhead of CSI-RS transmission is needed.

### Beam Indication

In NR, several signals can be transmitted from different antenna ports of a same base station. These signals can have the same large-scale properties such as Doppler shift/spread, average delay spread, or average delay. These antenna ports are then said to be Quasi Co-Located (QCL).

If the UE knows that two of its antenna ports are QCL with respect to a certain parameter (e.g., Doppler spread), the UE can estimate that parameter based on one of the antenna ports and apply that estimate for receiving signal on the other antenna port.

For example, there may be a QCL relation between a CSI-RS for tracking RS (TRS) and the PDSCH DMRS. When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:

Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in NR to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to also receive this signal.

In NR, the spatial QCL relation for a DL or UL signal/channel can be indicated to the UE by using a “beam indication”. The “beam indication” is used to help the UE to find a suitable RX beam for DL reception, and/or a suitable TX beam for UL transmission. In NR, the “beam indication” for DL is conveyed to the UE by indicating a Transmission Configuration Indicator (TCI) state to the UE, while in UL the “beam indication” can be conveyed by indicating a DL-RS or UL-RS as spatial relation (in NR Rel-15/16) or a TCI state (in NR Rel-17).

### Beam Link Failure Procedure

Blocking is expected to be common in the above 6 GHz regime due to the narrow beams used at both the TRP and UE and the high penetration loss and diffraction loss at these high frequencies. To handle blocking at higher frequencies in NR a beam recovery procedure has been standardized (instead of relying on Radio Link Failure (RLF) which is a much more costly and time-consuming procedure). The purpose of the beam recovery procedure is to find an alternative Beam Pair Link (BPL) in case the active beam pair link is blocked, as illustrated in FIG. 4. The UE beam failure recovery mechanism consists of four parts:
1. Beam Failure Detection
   a. The UE detects beam failure by monitoring a dedicated reference signal (CSI-RS or SSB) that is spatially QCL with PDCCH and assesses if a trigger condition has been met. The trigger condition is based on BLER for a hypothetical PDCCH based on the measurements on the dedicated DL-RS. A trigger condition is met (i.e., a beam link failure is declared) if the BLER for the hypothetical PDCCH is above a given threshold for X number of consecutive occasions (where X is configurable).
2. New Candidate Beam Identification
   a. In order to quickly find a candidate BPL after a beam link failure, the UE constantly monitors (i.e., measures RSRP on) beam identification RS, which for example can be SSB (or periodic CSI-RS if configured). Since SSB is expected to be beamformed at higher frequencies to attain coverage, the UE can determine a preferred candidate TRP SSB beam based on these measurements. Since each SSB consists of four OFDM symbols, the UE can also perform a UE RX beam sweep during each SSB transmission, and hence it is possible for the UE to determine both a suitable TRP beam and UE beam for the candidate BPL.
3. Beam Failure Recovery Request Transmission
   a. When the UE has declared a beam link failure and a new candidate beam has been determined, the UE transmits a Beam Failure Recovery Request (BFRQ) on UL to notify the network about the beam link failure. The BFRQ is a PRACH which implicitly informs the TRP about the preferred TRP SSB beam.
4. UE Monitors gNB Response For Beam Failure Recovery Request Response
   a. UE monitors for a beam failure recovery request response from the network on the new candidate beam pair link to finalize the beam link recovery procedure.

As used herein, the terminology “repeater node” refers to a network-controlled repeater or a Reconfigurable Intelligent Surface (RIS) or nodes with similar types of functionality, i.e., receiving a signal and instantaneously forwarding it in another direction, unless otherwise stated. Improved systems and methods for managing a repeater node are needed.

### SUMMARY

Systems and methods for joint-repeater-UE beam reporting in repeater-assisted networks are provided. In some embodiments, a method performed by a wireless network node for monitoring a connection to a UE through a repeater node includes: configuring the UE and/or the repeater node with one or more beam reports containing reference signals for evaluating one or more links between one or more of the group consisting of: the wireless network node, the repeater node, and the UE; triggering one or more of the configured beam reports; transmitting one or more configured reference signals associated with the triggered beam reports; and receiving the one or more beam reports.

Certain aspects of the disclosure and their embodiments may provide solutions to these or other challenges. The goals of some embodiments of the current disclosure are to develop overhead-efficient methods for radio link monitoring in the presence of a repeater node to activate the beam and/or link recovery process. Here, the methods also include identification of potential performance degradation and link failure of the service link and/or the access link, respectively. Thereby, appropriate beam report(s) can be performed which is needed to ensure a robust connection in a repeater-assisted network. This addresses one of the main objectives of the Rel-18 NCR SID regarding the control of repeater beamform functionality.

In some embodiments, a method performed by a wireless network node for monitoring a connection to a User Equipment, UE, through a repeater node, the method comprising one or more of: determining a set of X beam pair links between the wireless network node and the repeater node; determining a set of Y candidate repeater beams between the repeater node and the UE; configuring one or more beam reports containing reference signals for evaluating the one or more links between the wireless network and the UE; configuring the UE with a UE-only beam report containing Y reference signals to be used for evaluating Y repeater beams for the access link; configuring the UE with a joint-repeater-UE beam report containing X+Y reference signals to be used for evaluating X wireless network node beams for the service link and Y repeater beam for the access link; monitoring the radio link performance and determining where the potential beam link failure is taken place; triggering one or more of the pre-configured beam reports; transmitting one or more pre-configured reference signals associated with the triggered beam reports; and receiving the one or more beam reports.

Certain embodiments may provide one or more of the following technical advantage(s). Some embodiments of the current disclosure provide methods for detecting a beam link failure in the presence of a repeater node to enable a quick re-establishment of the beam links between gNB and UE through a repeater node. Particularly, the overhead of the beam report procedure is reduced considerably, compared to, e.g., performing an extensive beam sweep procedure comparing different combinations of the gNB beams and the repeater beams. The methods also include a determination on whether a beam link failure is due to failed service link and/or failed access link, in order to activate the appropriate beam report for re-establishing new beam pair link, and thereby reduce the processing time for beam recovery and improve the robustness and availability of the repeater-assistant network. This addresses one of the main objectives of the Rel-18 NCR SID regarding the control of repeater beamform functionality.

### BRIEF DESCRIPTION OF THE DRAWINGS

The accompanying drawing figures incorporated in and forming a part of this

specification illustrate several aspects of the disclosure, and together with the description serve to explain the principles of the disclosure.

FIG. 1 gives an example of a Network-Controlled Repeater (NCR) node deployment where the wireless connection between the NCR node and the gNB is referred to as service link, whereas the wireless connection between the NCR node and the UE is referred to as access link;

FIG. 2 illustrates one schematic example of how an NCR can be implemented;

FIG. 3 illustrates that beam management has been divided into three procedures;

FIG. 4 illustrates that a purpose of the beam recovery procedure is to find an alternative Beam Pair Link (BPL) in case the active beam pair link is blocked;

FIG. 5 illustrates the potential link failure in the service link (gNB-repeater), and/or the access link (e.g., repeater-User Equipment (UE)), in accordance with some embodiments;

FIG. 6 illustrates the possibly different periodicity of a UE-specific reference signal and the repeater (RP)-specific reference signal, in accordance with some embodiments;

FIG. 7A illustrates the X gNB beams corresponds to X number of candidate beam pair links previously determined due to static deployments, in accordance with some embodiments;

FIG. 7B illustrates the gNB transmits Y Downlink Reference Signals (DL-RS) using a wide gNB beam in the service link, while the repeater node forwards the Y DL-RSs to the UE in the access link will sweep through Y candidate repeater beams, in accordance with some embodiments;

FIGS. 8A and 8B illustrate methods of implementing some of the embodiments disclosed herein;

FIG. 9 shows an example to illustrate the operations at gNB, repeater node and UE, respectively, in the resource configured for reference signal transmission (TX), reception (RX), forwarding and reporting, in accordance with some embodiments;

FIG. 10 shows an example of a communication system in accordance with some embodiments;

FIG. 11 shows a UE in accordance with some embodiments;

FIG. 12 shows a network node in accordance with some embodiments;

FIG. 13 is a block diagram of a host, which may be an embodiment of the host of FIG. 10, in accordance with various aspects described herein, in accordance with some embodiments;

FIG. 14 is a block diagram illustrating a virtualization environment in which functions implemented by some embodiments may be virtualized, in accordance with some embodiments; and

FIG. 15 shows a communication diagram of a host communicating via a network node with a UE over a partially wireless connection, in accordance with some embodiments.

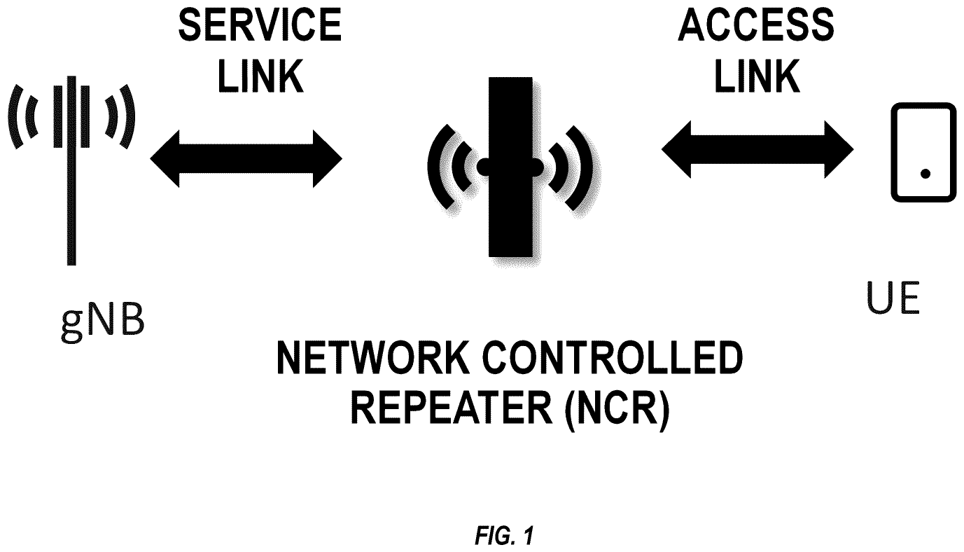

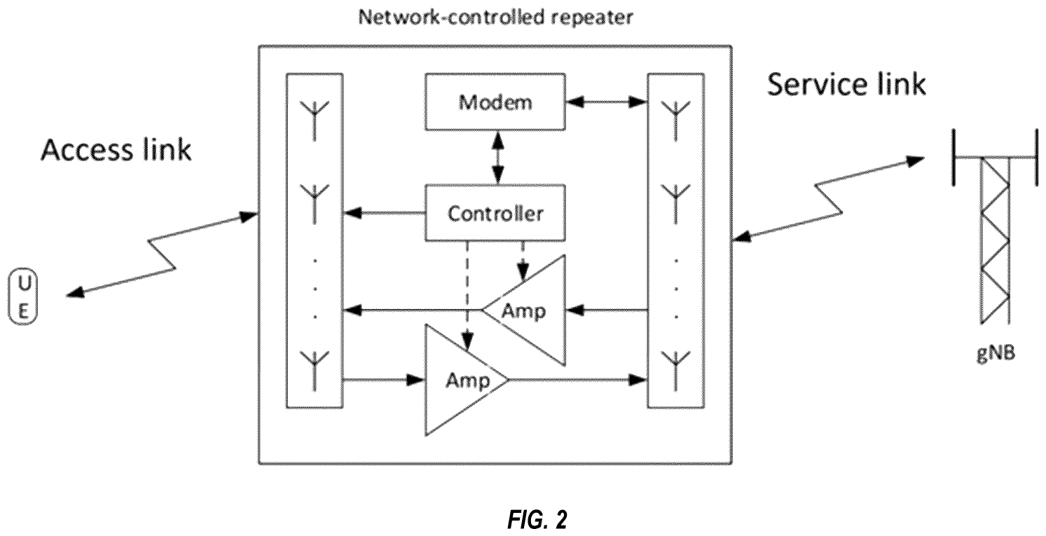

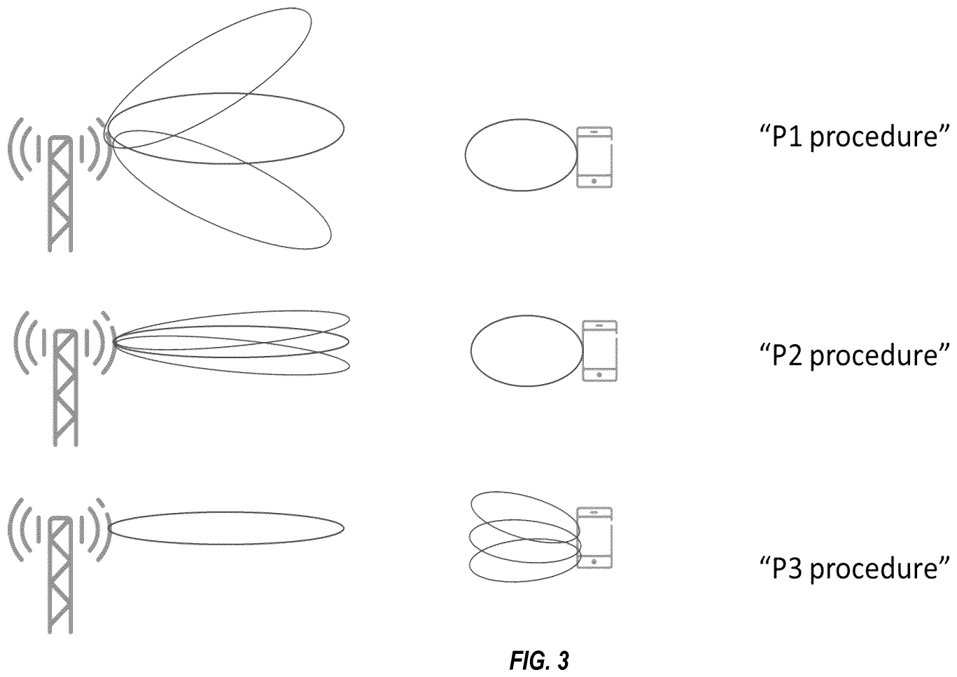

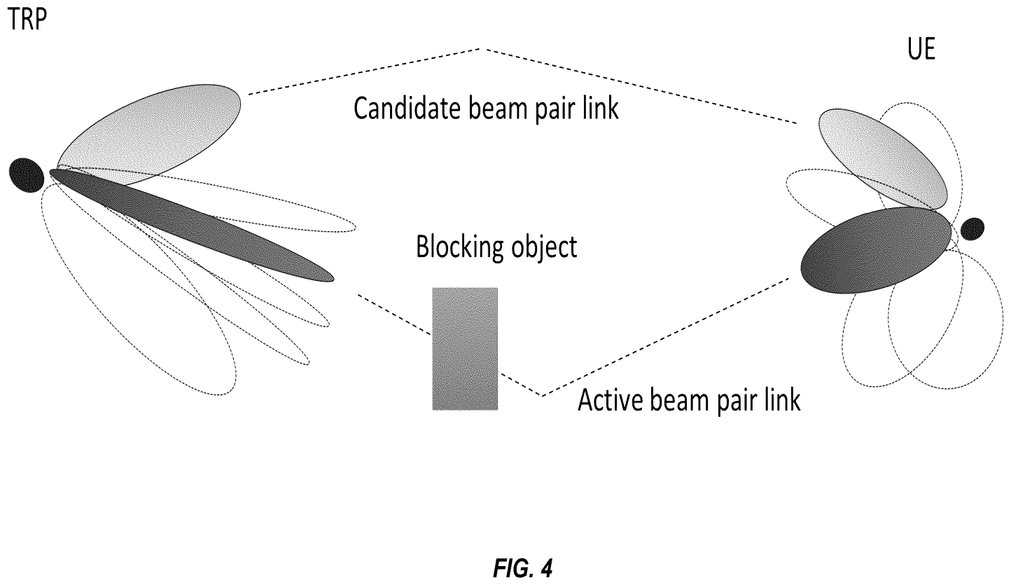

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

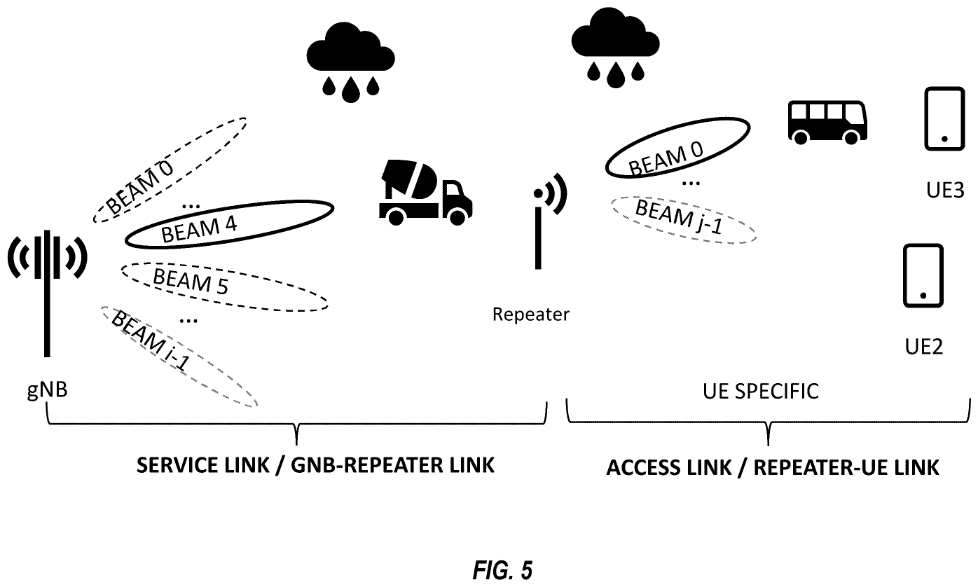

As depicted in FIG. 5, the system model considers a source node (e.g., a gNB) communicating with one or more destination nodes (e.g., UEs) in wireless communication links that are relayed by a repeater node (e.g., network-controlled repeater or intelligent surface etc.). FIG. 5 illustrates the potential link failure in the service link (gNB-repeater), and/or the access link (repeater-UE). FIG. 5 illustrates UEs are served by a gNB with an assisting repeater node. During operation, it could happen that any of the service link (gNB-repeater link) and/or the access link (repeater-UE link) becomes broken due to, additional interference or the obstacles in the propagation paths, e.g., the construction truck in the service link, or the bus in the access link, or atmospheric induced degradation such as rain, snow etc. In case of sudden link degradation events, it will be good to quickly identify the failed link(s) and/or beam(s) to initialize the appropriate beam recovery procedure which is needed for a robust connection.

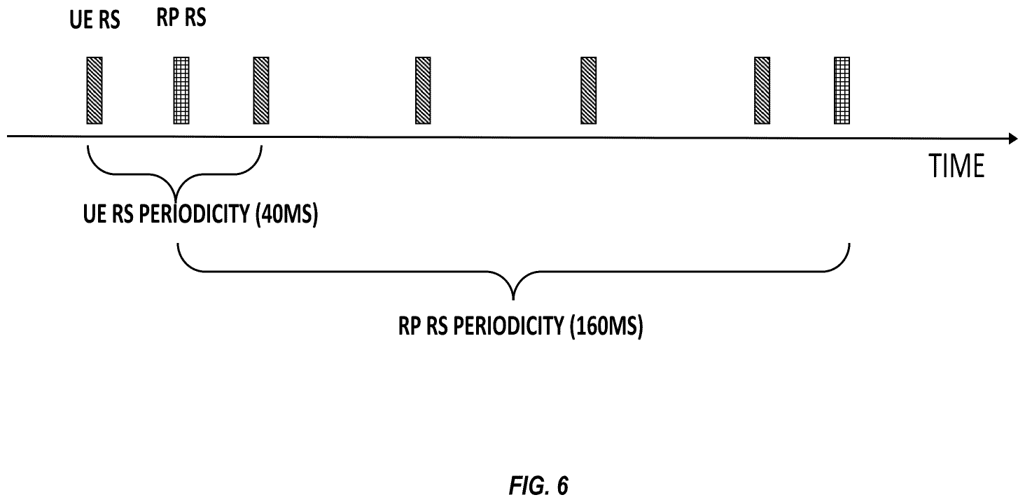

Following the legacy radio link monitoring framework, the service link (between gNB and repeater node) and the access link (between repeater node and UE) can be configured with separate reference signals and beam reports. The repeater node and the UE will include the candidate beams in the respective measurement reports. However, the above-described solution is not efficient in a repeater-assistant network, due to the following reasons. The service link is a planned link between two fixed nodes which means the service link is expected to use a fixed beam pair between the gNB and the repeater node. It is also expected that the service link should have stable performance and operates with Line-of-sight condition. On the other hand, the access link can change beam pairs between the repeater node and UE depending on which UE is currently served by the repeater node. In addition, due to the mobile nature of the UE, the access link will have more rapid channel variation. FIG. 6 illustrates the possibly different periodicity of a UE-specific reference signal (diagonal stripes) and the repeater (RP)-specific reference signal (small grid). FIG. 6 illustrates that the reference signals used for link monitoring of the service link can be configured with longer periodicity than those used for access link due to the stable propagation condition in the service link. It is also noted that a poor measurement report from the UE does not necessarily mean a failure of the access link, it can also be caused by a disturbance in the service link. The uncertainty in a poor UE measurement report is not desirable. Therefore, there is a need for solutions to fast identify the problematic link(s) and determine whether the link failure is taken place in the service link, and/or in the access link. From a network stability point of view, it is important to rescue a failed service link with low latency since the service link is used to serve multiple UEs in the repeater-assisted network.

Certain aspects of the disclosure and their embodiments may provide solutions to these or other challenges. Some embodiments of the current disclosure develop overhead-efficient methods for radio link monitoring in the presence of a repeater node to activate the beam and/or link recovery process. Here, the methods also include identification of potential performance degradation and link failure of the service link and/or the access link, respectively. Thereby, appropriate beam report(s) can be performed which is needed to ensure a robust connection in a repeater-assisted network. This addresses one of the main objectives of the Rel-18 NCR SID regarding the control of repeater beamform functionality.

Systems and methods for joint-repeater-UE beam reporting in repeater-assisted networks are provided. In some embodiments, a method performed by a wireless network node for monitoring a connection to a UE through a repeater node includes: configuring the UE with one or more beam reports containing reference signals for evaluating one or more links between one or more of the group consisting of: the wireless network and the UE; triggering one or more of the configured beam reports; transmitting one or more configured reference signals associated with the triggered beam reports; and receiving the one or more beam reports.

Some embodiments of the current disclosure provide methods for detecting a beam link failure in the presence of a repeater node to enable a quick re-establishment of the beam links between gNB and UE through a repeater node. Particularly, the overhead of the beam report procedure is reduced considerably, compared to, e.g., performing an extensive beam sweep procedure comparing different combinations of the gNB beams and the repeater beams. The methods also include a determination on whether a beam link failure is due to failed service link and/or failed access link, in order to activate the appropriate beam report for re-establishing new beam pair link, and thereby reduce the processing time for beam recovery and improve the robustness and availability of the repeater-assistant network. This addresses one of the main objectives of the Rel-18 NCR SID regarding the control of repeater beamform functionality.

In some embodiments, a method performed by a wireless network node for monitoring a connection to a User Equipment, UE, through a repeater node, the method comprising one or more of: determining a set of X beam pair links between the wireless network node and the repeater node; determining a set of Y candidate repeater beams between the repeater node and the UE; configuring one or more beam reports containing reference signals for evaluating the one or more links between the wireless network and the UE; configuring the UE with a UE-only beam report containing Y reference signals to be used for evaluating Y repeater beams for the access link; configuring the UE with a joint-repeater-UE beam report containing X+Y reference signals to be used for evaluating X wireless network node beams for the service link and Y repeater beam for the access link; monitoring the radio link performance and determining where the potential beam link failure is taken place; triggering one or more of the pre-configured beam reports; transmitting one or more pre-configured reference signals associated with the triggered beam reports; and receiving the one or more beam reports.

Certain embodiments may provide one or more of the following technical advantage(s). Some embodiments of the current disclosure provide methods for detecting a beam link failure in the presence of a repeater node to enable a quick re-establishment of the beam links between wireless network node and UE through a repeater node. Particularly, the overhead of the beam report procedure is reduced considerably, compared to, e.g., performing an extensive beam sweep procedure comparing different combinations of the wireless network node's beams and the repeater beams. The methods also include a determination on whether a beam link failure is due to failed service link and/or failed access link, in order to activate the appropriate beam report for re-establishing new beam pair link, and thereby reduce the processing time for beam recovery and improve the robustness and availability of the repeater-assistant network. This addresses one of the main objectives of the Rel-18 NCR SID regarding the control of repeater beamform functionality.

The method enables the wireless network node to, in addition to repeater-only and UE-only beam reports, configure a joint beam report at the UE to facilitate the determination on whether the beam failure is taken place at the service link between the wireless network node and the repeater node, or at the access link between the repeater node and UE.

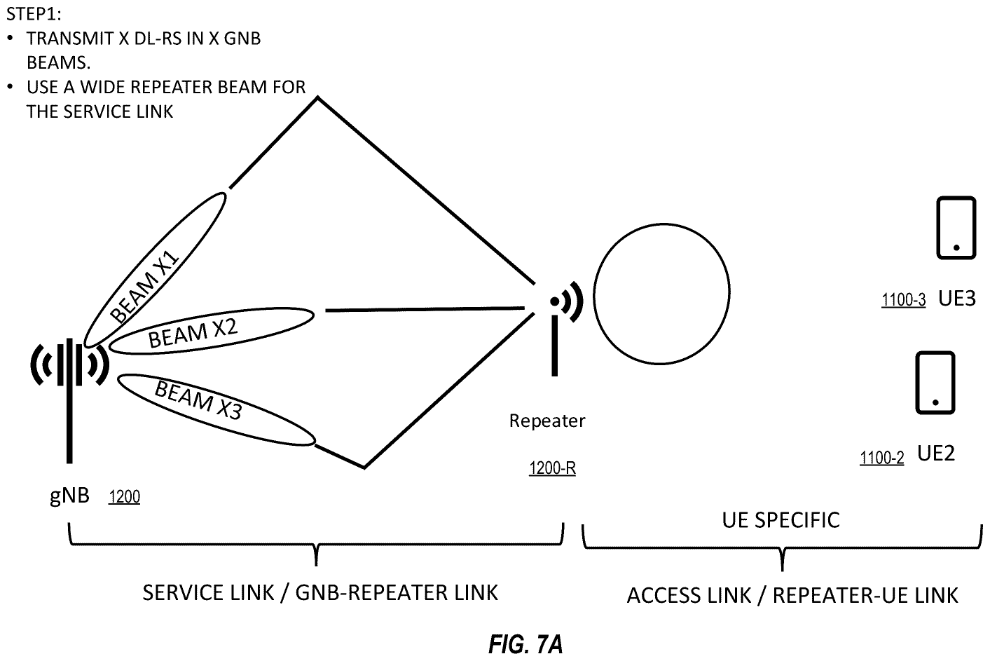

FIGS. 7A and 7B illustrate an example of a joint-repeater-UE beam report. The purpose of this method is to evaluate beams/beam pair links between both the gNB and repeater node as well as between the repeater node and UE in one single beam sweep procedure. By reducing it to a single beam sweep procedure the total latency and overhead can be reduced compared to triggering two separate beam sweep procedures, one for the service link, and one for the access link. For a joint-repeater-UE report, the gNB transmits the reference signals in two steps. In the first step, the gNB transmits in the service link X DL-RS in X gNB beams which are forwarded by the repeater to the UE in the access link using the same wide repeater beam. The X gNB beams corresponds to X number of candidate beam pair links previously determined due to static deployments (see FIG. 7A). In the second step, the gNB transmits Y DL-RS using a wide gNB beam in the service link (covering all the X beam pair links), while the repeater node (1200-R) forwards the Y DL-RSs to the UE in the access link will sweep through Y candidate repeater beams (sec FIG. 7B). In one embodiment, the order of these steps can change, where first the Y beams in the repeater-UE link are checked and followed by checking the X gNB beams in the gNB-repeater node link.

To determine a preferred gNB beam for the service link, the gNB determines which of the X DL-RS that are associated with best performance (e.g., highest reported RSRP), and to determine a preferred repeater beam for the access link, the gNB has to determine which of the Y DL-RSs that is associated with best performance (e.g., highest reported RSRP). In one detailed embodiment, to make sure that the beam report consists of at least one reported beam from the X gNB beams, and at least one reported beam from the Y repeater beams (which is desired to attain the full beam pair link between the gNB and the UE), the gNB can configure a single aperiodic trigger state containing two separate beam report settings, and where a first beam report setting is associated with a reference signal resource set with X DL-RS (which is used to report the best N beams of the X gNB beams) and the second beam report setting is associated with a reference signal resource set with Y DL-RS (which is used to report the best N beams of the Y repeater beams). One benefit with this solution is that it can determine the best gNB beam and best repeater beam for a UE with limited overhead (compared to performing an extensive beam sweep procedure comparing all combinations of gNB beams and repeater beams, which would result in X*Y DL-RSs, instead of X+Y DL-RS that is needed for this method).

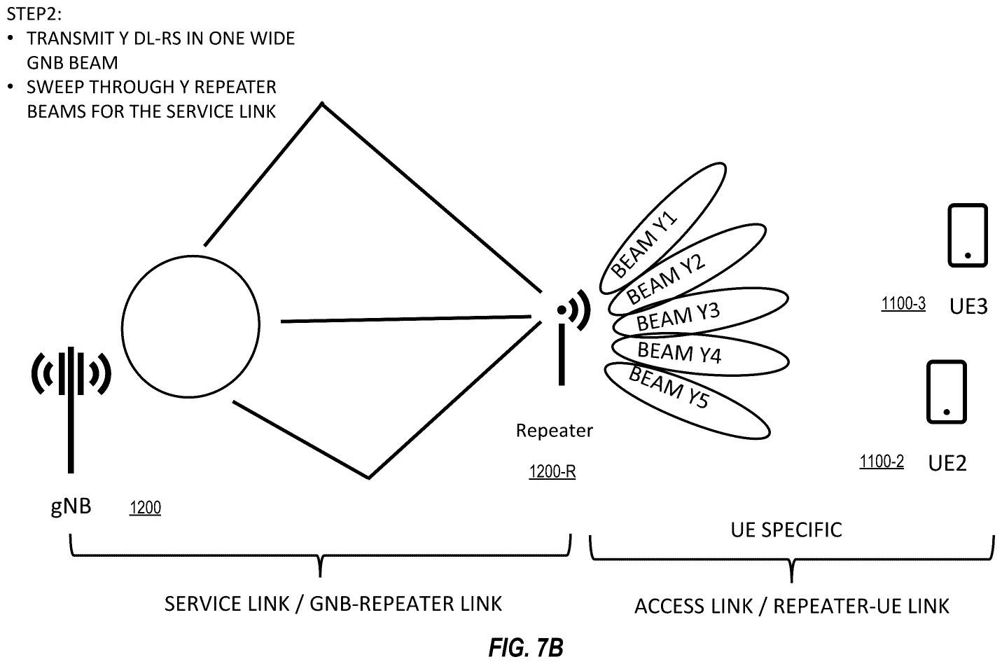

FIG. 8A illustrates a method of implementing some of the embodiments disclosed herein. In some embodiments, a method performed by a wireless network node (1200) for monitoring a connection to a UE (1100) through a repeater node includes: configuring (step 800) the UE (1100) with one or more beam reports containing reference signals for evaluating one or more links between one or more of the group consisting of: the wireless network node, the repeater node, and the UE (1100); triggering (step 802) one or more of the configured beam reports; transmitting (step 804) one or more configured reference signals associated with the triggered beam reports; and receiving (step 806) the one or more beam reports.

FIG. 8B illustrates a method of implementing some of these embodiments. In the Step (100), after establishment/integration of the repeater node to the network, the gNB determines a set of X beam pair links (BPL) for the service link, based on e.g., measured RSRP, or SINR etc. Since the deployment is expected to be rather static, the set of X BPLs can be determined rather rarely, for example once a day, week, month or similar to, e.g., adapt to changes in the season due to leaves in trees, etc. The determination of the X beam pair links can for example be done using P1, P2 and P3 beam sweep between the gNB and repeater node (it is expected that the repeater modem will have those functionalities supported). The main reason for determining a set of X candidate beam pair links is to handle the case where for example one of the X beam pair links gets blocked, then the gNB can switch to another of the X beam pair links. In one detailed embodiment, the X beam pair links are selected as the X BPLs with highest RSRP or SINR. In another detailed embodiment, the X BPLs are determined based on a performance threshold, such that all the beam pair links with an RSRP or SINR higher than a threshold value is included in the X BPLs. In yet another embodiment, the determination of the beam pair links is done by an extensive search of BPLS connected between the gNB and the repeater node. In yet another embodiment, the determination of set of BPLs can be performed independently for the two polarizations. Thereby, the set of BPLs of one polarization can be different from the set of beam pair links of the other polarization.

In the Step (101), the gNB determines a set of Y candidate repeater beams for the access link, based on e.g., previous beam measurement reports from the UE. For example, in case the UE has reported a previously best repeater beam, the candidate beams can be the repeater beams in close vicinity to the previously reported best repeater beam, i.e., similar to a P2 beam sweep (which could be useful for example if the UE has moved out from the current best repeater beam, then it is likely that another repeater beam pointing in approximately the same direction as the previous best repeater beam would be useful instead). In another embodiment, the Y candidate repeater beams consist of all possible wide repeater beams, i.e., similar to a P1 beam sweep (which could be useful for example if we do not really know in which direction a preferred repeater beam will point at to the UE, which is more common in non-LOS scenario, compared to LOS scenario). In yet another embodiment, the Y candidate repeater beams consist of all possible narrow repeater beams.

After the determination of X BPLs for the service link and Y candidate repeater beams for the access link, the gNB can configure the repeater node, and/or UE, with one or more beam measurement reports as described in the step (102)-(104) below.

In a Step (102), the gNB configures the repeater node with a repeater-only beam report containing X reference signals to be used for evaluating the said X gNB beams for the access link. In one embodiment, the reference signal configuration, and beam report configuration use e.g., RRC, or MAC CE signaling. In another embodiment, the reference signals can be e.g., SSB, CSI-RS, etc. In yet another embodiment, the beam report can be triggered using e.g., RRC, and/or MAC-CE, and/or DCI signaling.

In an optional Step (103), the gNB configures the UE with a UE-only beam report containing Y reference signals to be used for evaluating Y repeater beams for the access link. In one embodiment, the reference signal configuration, and beam report configuration use e.g., RRC, or MAC CE signaling. In another embodiment, the reference signals can be e.g., SSB, CSI-RS etc. In yet another embodiment, the beam report can be triggered using e.g., RRC, and/or MAC-CE, and/or DCI signaling.

In one embodiment, the gNB will provide to the repeater node repeater-specific configurations which are associated to a UE-only beam report including one or more of: a repeater node operation mode configuration e.g., forwarding, DL/UL, ON/OFF, etc.; and a repeater beam mapping configuration e.g., a mapping between repeater node TX beams and the Y reference signals.

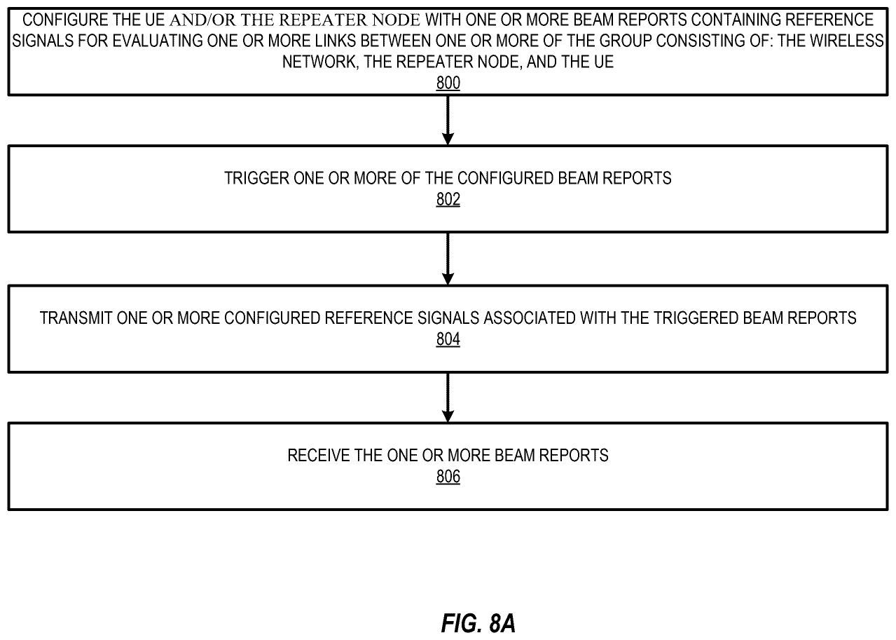

FIG. 9 shows an example to illustrate the operations at gNB, repeater node and UE, respectively, in the resource configured for reference signal transmission (TX), reception (RX), forwarding and reporting. For example, in the resource configured for UE-specific-RS, gNB transmits UE-specific-RS to UE and receives measurement report on the said reference signals from UE. Meanwhile, the repeater node forwards the reference signals transmitted from the gNB to UE in the downstream direction, whilst in the upstream direction the repeater node forwards the measurement report from UE to the gNB. Finally, the UE receives UE-specific-RS from the gNB and reports the measurement results to the gNB. In the resource configured for repeater (RP)-specific-RS, the gNB transmits RP-specific-RS to the repeater node and receives the measurement report from the repeater node. At the same time, the repeater node receives the RP-specific-RS from the gNB and reports the measurement results to the gNB.

In an optional Step (104), the gNB configures to UE a joint-repeater-UE beam report containing X+Y reference signals to be used for evaluating X gNB beams for the service link and Y repeater beam for the access link, as described in FIGS. 7A and 7B. In one embodiment, the gNB will provide to the repeater node repeater-specific

configurations which are associated to a Joint-repeater-UE beam report including one or more of: a repeater node operation mode configuration e.g., forwarding, DL/UL, ON/OFF, etc.; and a repeater beam mapping configuration e.g., a mapping between repeater node TX beams and the Y reference signals.

In the Step (105), the gNB monitors the radio link performance and determines where the potential beam link failure has taken place. There are different ways for the gNB to determine failed/deteriorated link(s):

In one embodiment, the determination of failed link(s) is based on the measurement report of the configured reference signals. In one example, if a poor measurement report is received from the repeater node, the potential failed link is with the service link and the gNB only needs to activate the beam report for the service link. In another example, if a poor measurement report is received from the UE, the potential failed link can be any or both of the service link and the access link. Hence, the gNB has to handle the uncertainty of a poor UE beam report.

In one embodiment, the gNB determines the failure of the service link based on performance drops which are detected simultaneously for all the UEs served by the repeater node. It is likely that the service link between the gNB and the repeater node is deteriorated.

In one embodiment, the gNB determines the failure of an access link based on performance drops are not detected simultaneously for all the UEs served by the repeater node, but only the group of UEs which are served by a specific repeater beam. It is likely that the access link between the repeater node and UE is broken.

In one embodiment, the gNB can monitor repeater specific control and/or data channel, such as repeater specific PDCCH/PDSCH/PUCCH/PUSCH. In one example, the gNB can perform measurement on the quality of the UL signals transmitted from the repeater node to gNB. In another example, the gNB can perform measurement on the quality of the received ACK/NACK signal from the repeater node to evaluate if the service link is sufficiently good or not. In yet another example where the repeater node is informed by the gNB to switch the serving beam to serve a second UE. If the gNB does not receive UL signals from the second UE, it is likely the service link is broken and the gNB can activate the candidate beam identification for the service link.

In some embodiments, the gNB can detect failure between the network node and the UE. However, determining whether the failure between the network node and a UE is based on a failure between the network node and the repeater node (i.e., for the service link) or if the failure is between the repeater node and the UE (i.e., for the access link) is sometimes used. Based on where the failure is occurring, one of the three different configured beam sweeps can be triggered, according to some embodiments.

In the Step (106), the gNB triggered the pre-configured beam report(s) for the service link, and/or the access link, based on the determination of the failed link(s) from the step (106). In some embodiments, the link from the gNB to the NCR is called a “Donor Link” and the link from the NCR to the UE is called a “Service Link.”

In one embodiment, the gNB triggers a repeater-only beam report in case the failed/deteriorated connection between gNB and UE is estimated to be a result of failed/deteriorated service link.

In one embodiment, the gNB triggers a UE-only beam report in case the failed/deteriorated connection between gNB and UE is estimated to be a result of failed/deteriorated access link.

In one embodiment, the gNB triggers both a repeater-only beam report and a UE-only beam report in case it is uncertain if the failed/deteriorated connection between gNB and UE is a result of failed/deteriorated access link or failed/deteriorated service link.

In one embodiment, the gNB triggers a joint-repeater-UE beam report and a UE-only beam report in case it is uncertain if the failed/deteriorated connection between gNB and UE is a result of failed/deteriorated access link or failed/deteriorated service link.

In the Step (107), the gNB transmits the pre-defined reference signals from the Steps (100) and (101) to the repeater node and UE, respectively.

In one embodiment, the X DL-RSs of the joint-repeater-UE beam report are transmitted in X candidate gNB beams, received and amplified by the repeater node and then forwarded/transmitted by the repeater node using a wide repeater beam of the access link, sec FIG. 7A.

In another embodiment, the Y DL-RSs of the joint-repeater-UE beam report are transmitted in a single wide gNB beam, received and amplified by the repeater node, and then forwarded/transmitted by the repeater node using Y different repeater beams for the access link, see FIG. 7B.

In the Step (108), the gNB receives the said beam measurement report(s) from the Step (107) from the repeater node and/or UE. In one embodiment, the gNB receives the joint-repeater-UE beam report from the UE. Based on the said joint-repeater-UE beam report, the gNB determines a preferred (candidate) gNB beam for the service link and a preferred (candidate) repeater beam for the access link.

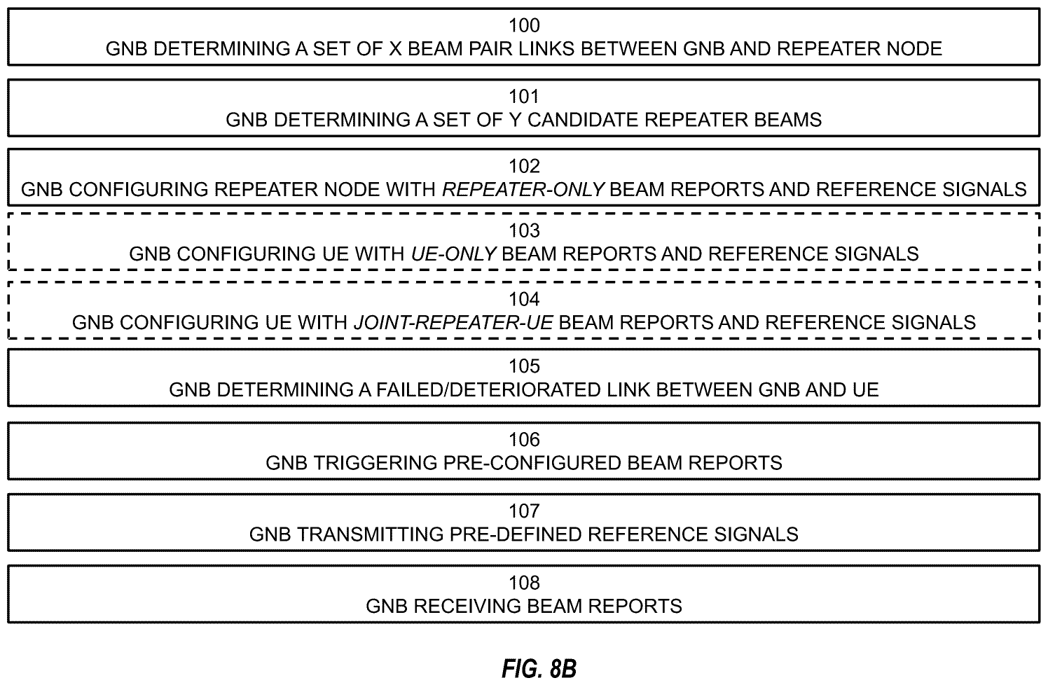

FIG. 10 shows an example of a communication system 1000 in accordance with some embodiments. In the example, the communication system 1000 includes a telecommunication network 1002 that includes an access network 1004, such as a Radio Access Network (RAN), and a core network 1006, which includes one or more core network nodes 1008. The access network 1004 includes one or more access network nodes, such as network nodes 1010A and 1010B (one or more of which may be generally referred to as network nodes 1010), or any other similar Third Generation Partnership Project (3GPP) access node or non-3GPP Access Point (AP). The network nodes 1010 facilitate direct or indirect connection of User Equipment (UE), such as by connecting UEs 1012A, 1012B, 1012C, and 1012D (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002 and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system 1000 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1002 is a cellular network that implements 3GPP standardized features. Accordingly, the telecommunication network 1002 may support network slicing to provide different logical networks to different devices that are connected to the telecommunication network 1002. For example, the telecommunication network 1002 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single-or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 1014 communicates with the access network 1004 to facilitate indirect communication between one or more UEs (e.g., UE 1012C and/or 1012D) and network nodes (e.g., network node 1010B). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a Virtual Reality (VR) headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular if one or more of the UEs are low energy IoT devices.

The hub 1014 may have a constant/persistent or intermittent connection to the network node 1010B. The hub 1014 may also allow for a different communication scheme and/or schedule between the hub 1014 and UEs (e.g., UE 1012C and/or 1012D), and between the hub 1014 and the core network 1006. In other examples, the hub 1014 is connected to the core network 1006 and/or one or more UEs via a wired connection. Moreover, the hub 1014 may be configured to connect to a Machine-to-Machine (M2M) service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub-that is, a hub whose primary function is to route communications to/from the UEs from/to the network node 1010B. In other embodiments, the hub 1014 may be a non-dedicated hub-that is, a device which is capable of operating to route communications between the UEs and the network node 1010B, but which is additionally capable of operating as a communication start and/or end point for certain data channels.

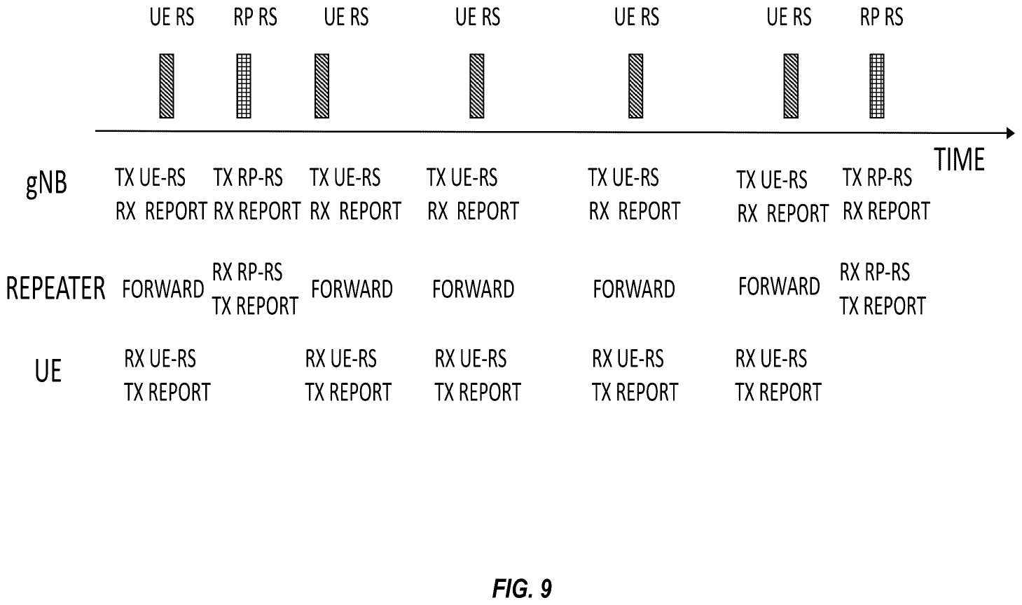

FIG. 11 shows a UE 1100 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic,

Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1102 may include multiple Central Processing Units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging the power source 1108. Power circuitry may perform any formatting, converting, or other modification to the power from the power source 1108 to make the power suitable for the respective components of the UE 1100 to which power is supplied.

The memory 1110 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1110 may allow the UE 1100 to access instructions, application programs, and the like stored on transitory or non-transitory memory media, to off-load data, or to upload data. An article of manufacture, such as one utilizing a communication system, may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., the antenna 1122) and may share circuit components, software, or firmware, or alternatively be implemented separately.

In the illustrated embodiment, communication functions of the communication interface 1112 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1112, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Acrial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

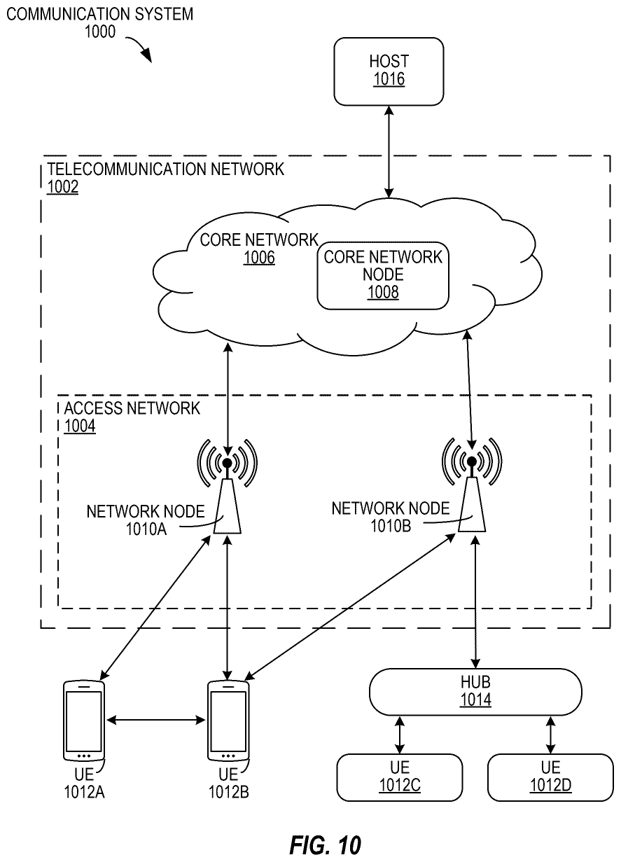

FIG. 12 shows a network node 1200 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (cNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes processing circuitry 1202, memory 1204, a communication interface 1206, and a power source 1208. The network node 1200 may be composed of multiple physically separate components (e.g., a Node B component and an RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1200 may be configured to support multiple RATs. In such embodiments, some components may be duplicated (e.g., separate memory 1204 for different RATs) and some components may be reused (e.g., an antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1200.

The processing circuitry 1202 may comprise a combination of one or more of a microprocessor, controller, microcontroller, CPU, DSP, ASIC, FPGA, or any other suitable computing device, resource, or combination of hardware, software, and/or encoded logic operable to provide, cither alone or in conjunction with other network node 1200 components, such as the memory 1204, to provide network node 1200 functionality.

In some embodiments, the processing circuitry 1202 includes a System on a Chip (SOC). In some embodiments, the processing circuitry 1202 includes one or more of Radio Frequency (RF) transceiver circuitry 1212 and baseband processing circuitry 1214. In some embodiments, the RF transceiver circuitry 1212 and the baseband processing circuitry 1214 may be on separate chips (or sets of chips), boards, or units, such as radio units and digital units. In alternative embodiments, part or all of the RF transceiver circuitry 1212 and the baseband processing circuitry 1214 may be on the same chip or set of chips, boards, or units.

The memory 1204 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and the memory 1204 are integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. The radio front-end circuitry 1218 comprises filters 1220 and amplifiers 1222. The radio front-end circuitry 1218 may be connected to the antenna 1210 and the processing circuitry 1202. The radio front-end circuitry 1218 may be configured to condition signals communicated between the antenna 1210 and the processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of the filters 1220 and/or the amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface 1206 may comprise different components and/or different combinations of components.

In certain alternative embodiments, the network node 1200 does not include separate radio front-end circuitry 1218; instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes the one or more ports or terminals 1216, the radio front-end circuitry 1218, and the RF transceiver circuitry 1212 as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, the communication interface 1206, and/or the processing circuitry 1202 may be configured to perform any receiving operations and/or certain obtaining operations described herein as being performed by the network node 1200. Any information, data, and/or signals may be received from a UE, another network node, and/or any other network equipment. Similarly, the antenna 1210, the communication interface 1206, and/or the processing circuitry 1202 may be configured to perform any transmitting operations described herein as being performed by the network node 1200. Any information, data, and/or signals may be transmitted to a UE, another network node, and/or any other network equipment.

The power source 1208 provides power to the various components of the network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid or an electricity outlet) via input circuitry or an interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

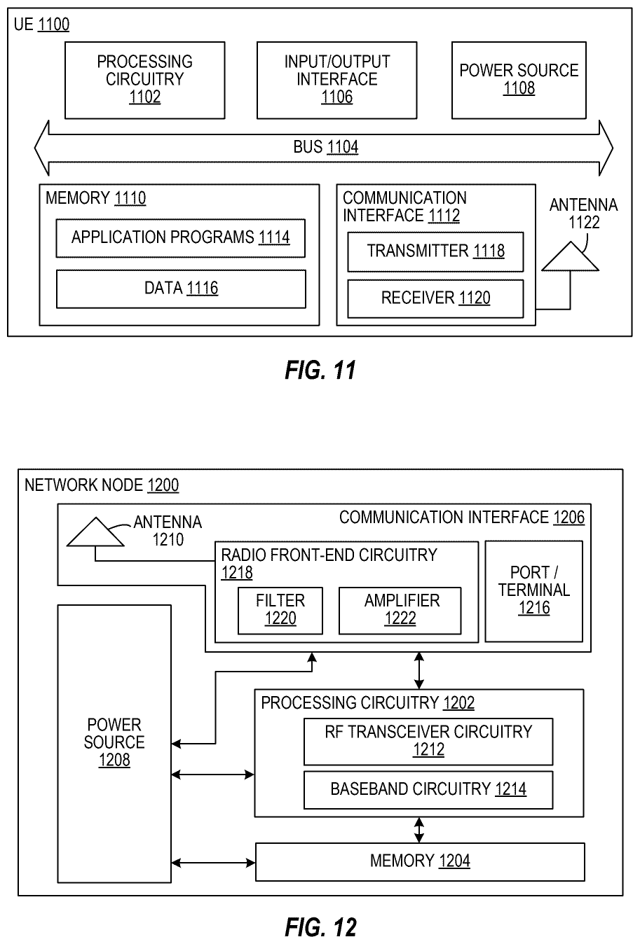

FIG. 13 is a block diagram of a host 1300, which may be an embodiment of the host 1016 of FIG. 10, in accordance with various aspects described herein. As used herein, the host 1300 may be or comprise various combinations of hardware and/or software including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and memory 1312. Other components may be included in other embodiments. Features of these components may be substantially similar to those described with respect to the devices of previous figures, such as FIGS. 11 and 12, such that the descriptions thereof are generally applicable to the corresponding components of the host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for Over-The-Top (OTT) services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

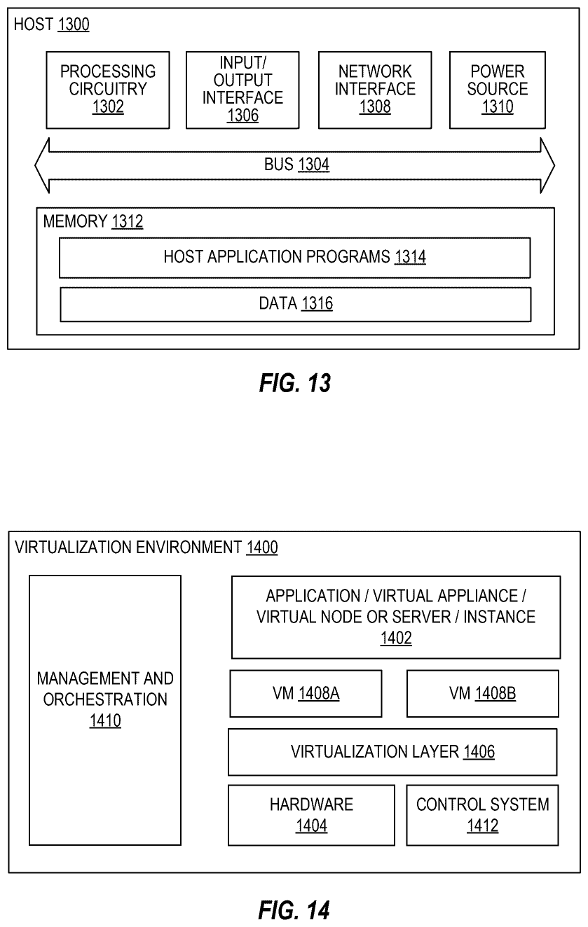

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or VM Monitors (VMMs)), provide VMs 1408A and 1408B (one or more of which may be generally referred to as VMs 1408), and/or perform any of the functions, features, and/or benefits described in relation with some embodiments described herein. The virtualization layer 1406 may present a virtual operating platform that appears like networking hardware to the VMs 1408.

The VMs 1408 comprise virtual processing, virtual memory, virtual networking, or interface and virtual storage, and may be run by a corresponding virtualization layer 1406. Different embodiments of the instance of a virtual appliance 1402 may be implemented on one or more of the VMs 1408, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1408 may be a software implementation of a physical machine that runs programs as if they were executing on a physical, non-virtualized machine. Each of the VMs 1408, and that part of the hardware 1404 that executes that VM, be it hardware dedicated to that VM and/or hardware shared by that VM with others of the VMs 1408, forms separate virtual network elements. Still in the context of NFV, a virtual network function is responsible for handling specific network functions that run in one or more VMs 1408 on top of the hardware 1404 and corresponds to the application 1402.

The hardware 1404 may be implemented in a standalone network node with generic or specific components. The hardware 1404 may implement some functions via virtualization. Alternatively, the hardware 1404 may be part of a larger cluster of hardware (e.g., such as in a data center or CPE) where many hardware nodes work together and are managed via management and orchestration 1410, which, among others, oversees lifecycle management of the applications 1402. In some embodiments, the hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1412 which may alternatively be used for communication between hardware nodes and radio units.

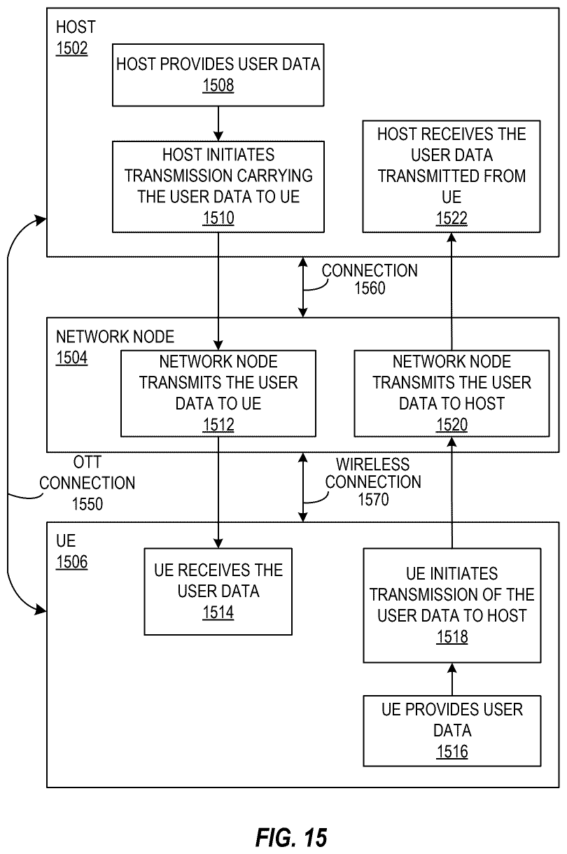

FIG. 15 shows a communication diagram of a host 1502 communicating via a network node 1504 with a UE 1506 over a partially wireless connection in accordance with some embodiments. Example implementations, in accordance with various embodiments, of the UE (such as the UE 1012A of FIG. 10 and/or the UE 1100 of FIG. 11), the network node (such as the network node 1010A of FIG. 10 and/or the network node 1200 of FIG. 12), and the host (such as the host 1016 of FIG. 10 and/or the host 1300 of FIG. 13) discussed in the preceding paragraphs will now be described with reference to FIG. 15.

Like the host 1300, embodiments of the host 1502 include hardware, such as a communication interface, processing circuitry, and memory. The host 1502 also includes software, which is stored in or is accessible by the host 1502 and executable by the processing circuitry. The software includes a host application that may be operable to provide a service to a remote user, such as the UE 1506 connecting via an OTT connection 1550 extending between the UE 1506 and the host 1502. In providing the service to the remote user, a host application may provide user data which is transmitted using the OTT connection 1550.

The network node 1504 includes hardware enabling it to communicate with the host 1502 and the UE 1506 via a connection 1560. The connection 1560 may be direct or pass through a core network (like the core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by the UE 1506 and executable by the UE's processing circuitry. The software includes a client application, such as a web browser or operator-specific “app” that may be operable to provide a service to a human or non-human user via the UE 1506 with the support of the host 1502. In the host 1502, an executing host application may communicate with the executing client application via the OTT connection 1550 terminating at the UE 1506 and the host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via the connection 1560 between the host 1502 and the network node 1504 and via a wireless connection 1570 between the network node 1504 and the UE 1506 to provide the connection between the host 1502 and the UE 1506. The connection 1560 and the wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504 in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR, or AR which it can broadcast, multicast, or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1550 between the host 1502 and the UE 1506 in response to variations in the measurement results. The measurement procedure and/or the network functionality for reconfiguring the OTT connection 1550 may be implemented in software and hardware of the host 1502 and/or the UE 1506. In some embodiments, sensors (not shown) may be deployed in or in association with other devices through which the OTT connection 1550 passes; the sensors may participate in the measurement procedure by supplying values of the monitored quantities exemplified above, or by supplying values of other physical quantities from which software may compute or estimate the monitored quantities. The reconfiguring of the OTT connection 1550 may include message format, retransmission settings, preferred routing, etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency, and the like by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardwarc.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

### EMBODIMENTS

### Group A Embodiments

Embodiment 1: A method performed by a User Equipment, UE, for enabling monitoring of a connection to a wireless network node, through a repeater node, the method comprising one or more of: receiving (103) a configuration of a UE-only beam report containing Y reference signals to be used for evaluating Y repeater beams for the access link; receiving (104) a configuration of a joint-repeater-UE beam report containing X+Y reference signals to be used for evaluating X wireless network node beams for the service link and Y repeater beam for the access link; and transmitting (108) one or more beam reports.

Embodiment 2: The method of the previous embodiment wherein receiving a configuration of the beam report comprises one or more of: receiving a configuration of a UE-only beam report containing Y reference signals to be used for evaluating Y repeater beams for the repeater-UE link; and receiving a configuration of a Joint-repeater-UE beam report containing X+Y reference signals to be used for evaluating X wireless network node beams for the service link and Y repeater beams for the access link.

Embodiment 3: The method of any of the previous embodiments further comprising: signaling a beam failure recovery request.

Embodiment 4: The method of any of the previous embodiments wherein the wireless network node comprises a gNB.

Embodiment 5: The method of any of the previous embodiments, further comprising: providing user data; and forwarding the user data to a host via the transmission to the network node.

### Group B Embodiments

Embodiment 6: A method performed by a wireless network node for monitoring a connection to a User Equipment, UE, through a repeater node, the method comprising one or more of: determining (100) a set of X beam pair links between the wireless network node and the repeater node; determining (101) a set of Y candidate repeater beams between the repeater node and the UE; configuring (102) one or more beam reports containing reference signals for evaluating the one or more links between the wireless network and the UE; configuring (103) the UE with a UE-only beam report containing Y reference signals to be used for evaluating Y repeater beams for the access link; configuring (104) the UE with a joint-repeater-UE beam report containing X+Y reference signals to be used for evaluating X wireless network node beams for the service link and Y repeater beam for the access link; monitoring (105) the radio link performance and determining where the potential beam link failure is taken place; triggering (106) one or more of the pre-configured beam reports; transmitting (107) one or more pre-configured reference signals associated with the triggered beam reports; and receiving (108) the one or more beam reports.

Embodiment 7: The method of the previous embodiment wherein configuring the beam report comprises one or more of: configuring the repeater node with a Repeater-only beam report containing X reference signals to be used for evaluating X wireless network node beams for the service link; configuring the UE with a UE-only beam report containing Y reference signals to be used for evaluating Y repeater beams for the repeater-UE link; and configuring the UE with a Joint-repeater-UE beam report containing X+Y reference signals to be used for evaluating X wireless network node beams for the service link and Y repeater beams for the access link.

Embodiment 8: The method of any of the previous embodiments wherein configuring a UE-only beam report comprises one or more of: providing the repeater node with associated beam mapping configuration; and providing the repeater node with a configuration on operation modes (e.g., forwarding, and/or ON/OFF, and/or DL/UL).

Embodiment 9: The method of any of the previous embodiments wherein configuring a Joint-repeater-UE beam reporting comprises one or more of: providing the repeater node with associated beam mapping configuration; and providing the repeater node with a configuration on operation modes (e.g., forwarding, and/or ON/OFF, and/or DL/UL).

Embodiment 10: The method of any of the previous embodiments wherein triggering the pre-configured beam reports is based on a determination of a failed/deteriorated connection between the wireless network node and UE served through the repeater node.

Embodiment 11: The method of any of the previous embodiments wherein determining the failed/deteriorated connection between the wireless network node and the UE is based on received signal quality from UL signals transmitted from the repeater node to the wireless network node (e.g., repeater specific control and/or data channels, such as repeater-specific PDCCH/PDSCH/PUCCH/PUSCH).

Embodiment 12: The method of any of the previous embodiments wherein determining the failed/deteriorated connection between the wireless network node and the UE is based on simultaneous detecting performance drop for several UE connections served through the repeater node.

Embodiment 13: The method of any of the previous embodiments wherein determining the failed/deteriorated connection between the wireless network node and the UE is based on a beam failure recovery request signaled from the repeater node to the wireless network node.

Embodiment 14: The method of any of the previous embodiments wherein determining the failed/deteriorated connection between the wireless network node and the UE is based on simultaneously detecting performance drop for the UE, while at the same time not detecting performance drop for other UEs served through the repeater node.

Embodiment 15: The method of any of the previous embodiments wherein determining the failed/deteriorated connection between the wireless network node and the UE is based on poor UL link quality from the UE.

Embodiment 16: The method of any of the previous embodiments wherein determining the failed/deteriorated connection between the wireless network node and the UE is based on a beam failure recovery request signaled from the UE.

Embodiment 17: The method of any of the previous embodiments wherein triggering a Repeater-only beam report in case the failed/deteriorated connection between the wireless network node and the UE is estimated to be a result of failed/deteriorated service link.

Embodiment 18: The method of any of the previous embodiments wherein triggering a UE-only beam report in case the failed/deteriorated connection between the wireless network node and the UE is estimated to be a result of failed/deteriorated access link.

Embodiment 19: The method of any of the previous embodiments wherein triggering both a Repeater-only beam report and a UE-only beam report in case it is uncertain if the failed/deteriorated connection between the wireless network node and the UE is a result of failed/deteriorated access link or failed/deteriorated service link.

Embodiment 20: The method of any of the previous embodiments wherein triggering a Joint-repeater-UE beam report in case it is uncertain if the failed/deteriorated connection between the wireless network node and the UE is a result of failed/deteriorated access link or failed/deteriorated service link.

Embodiment 21: The method of any of the previous embodiments wherein the X DL-RSs of the Joint-repeater-UE beam report are transmitted in X candidate the wireless network node beams, received and amplified by the repeater node, and then forwarded/transmitted by the repeater node using a wide repeater beam for the access link.

Embodiment 22: The method of any of the previous embodiments wherein the Y DL-RSs of the Joint-repeater-UE beam report are transmitted in a single wide the wireless network node beam, received and amplified by the repeater node, and then forwarded/transmitted by the repeater node using Y different repeater beams for the access link.

Embodiment 23: The method of any of the previous embodiments wherein the wireless network node receives the Joint-repeater-UE beam report from the UE, and based on the Joint-repeater-UE beam report, determines a preferred the wireless network node beam for the service link and a preferred repeater beam for the access link.

Embodiment 24: The method of any of the previous embodiments wherein the wireless network node comprises a gNB.

Embodiment 25: The method of any of the previous embodiments, further comprising: obtaining user data; and forwarding the user data to a host or a user equipment.

### Group C Embodiments

Embodiment 26: A user equipment for enabling monitoring of a connection to a wireless network node, comprising: processing circuitry configured to perform any of the steps of any of the Group A embodiments; and power supply circuitry configured to supply power to the processing circuitry.

Embodiment 27: A wireless network node and/or a repeater node for monitoring a connection to a User Equipment, UE, through a repeater node, the wireless network node and/or the repeater node comprising: processing circuitry configured to perform any of the steps of any of the Group B embodiments; power supply circuitry configured to supply power to the processing circuitry.

Embodiment 28: A user equipment (UE) for enabling monitoring of a connection to a wireless network node, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 29: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 30: The host of the previous embodiment, wherein the cellular network further includes a wireless network node and/or a repeater node configured to communicate with the UE to transmit the user data to the UE from the host.

Embodiment 31: The host of the previous 2 embodiments, wherein: the processing circuitry of the host is configured to execute a host application, thereby providing the user data; and the host application is configured to interact with a client application executing on the UE, the client application being associated with the host application.

Embodiment 32: A method implemented by a host operating in a communication system that further includes a wireless network node and/or a repeater node and a user equipment (UE), the method comprising: providing user data for the UE; and initiating a transmission carrying the user data to the UE via a cellular network comprising the wireless network node and/or the repeater node, wherein the UE performs any of the operations of any of the Group A embodiments to receive the user data from the host.

Embodiment 33: The method of the previous embodiment, further comprising: at the host, executing a host application associated with a client application executing on the UE to receive the user data from the UE.

Embodiment 34: The method of the previous embodiment, further comprising: at the host, transmitting input data to the client application executing on the UE, the input data being provided by executing the host application, wherein the user data is provided by the client application in response to the input data from the host application.

Embodiment 35: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 36: The host of the previous embodiment, wherein the cellular network further includes a wireless network node and/or a repeater node configured to communicate with the UE to transmit the user data from the UE to the host.

Embodiment 37: The host of the previous 2 embodiments, wherein: the processing circuitry of the host is configured to execute a host application, thereby providing the user data; and the host application is configured to interact with a client application executing on the UE, the client application being associated with the host application.

Embodiment 38: A method implemented by a host configured to operate in a communication system that further includes a wireless network node and/or a repeater node and a user equipment (UE), the method comprising: at the host, receiving user data transmitted to the host via the wireless network node and/or the repeater node by the UE, wherein the UE performs any of the steps of any of the Group A embodiments to transmit the user data to the host.

Embodiment 39: The method of the previous embodiment, further comprising: at the host, executing a host application associated with a client application executing on the UE to receive the user data from the UE.

Embodiment 40: The method of the previous embodiment, further comprising: at the host, transmitting input data to the client application executing on the UE, the input data being provided by executing the host application, wherein the user data is provided by the client application in response to the input data from the host application.

Embodiment 41: A host configured to operate in a communication system to provide an over-the-top (OTT) service, the host comprising: processing circuitry configured to provide user data; and a network interface configured to initiate transmission of the user data to a wireless network node and/or a repeater node in a cellular network for transmission to a user equipment (UE), the wireless network node and/or the repeater node having a communication interface and processing circuitry, the processing circuitry of the wireless network node and/or the repeater node configured to perform any of the operations of any of the Group B embodiments to transmit the user data from the host to the UE.

Embodiment 42: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 43: A method implemented in a host configured to operate in a communication system that further includes a wireless network node and/or a repeater node and a user equipment (UE), the method comprising: providing user data for the UE; and initiating a transmission carrying the user data to the UE via a cellular network comprising the wireless network node and/or the repeater node, wherein the wireless network node and/or the repeater node performs any of the operations of any of the Group B embodiments to transmit the user data from the host to the UE.

Embodiment 44: The method of the previous embodiment, further comprising, at the wireless network node and/or the repeater node, transmitting the user data provided by the host for the UE.

Embodiment 45: The method of any of the previous 2 embodiments, wherein the user data is provided at the host by executing a host application that interacts with a client application executing on the UE, the client application being associated with the host application.

Embodiment 46: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular wireless network node and/or a repeater node for transmission to the UE, the wireless network node and/or the repeater node having a communication interface and processing circuitry, the processing circuitry of the wireless network node and/or the repeater node configured to perform any of the operations of any of the Group B embodiments to transmit the user data from the host to the UE.

Embodiment 47: The communication system of the previous embodiment, further comprising: the wireless network node and/or the repeater node; and/or the user equipment.

Embodiment 48: A host configured to operate in a communication system to provide an over-the-top (OTT) service, the host comprising: processing circuitry configured to initiate receipt of user data; and a network interface configured to receive the user data from a wireless network node and/or a repeater node in a cellular network, the wireless network node and/or the repeater node having a communication interface and processing circuitry, the processing circuitry of the wireless network node and/or the repeater node configured to perform any of the operations of any of the Group B embodiments to receive the user data from a user equipment (UE) for the host.

Embodiment 49: The host of the previous 2 embodiments, wherein: the processing circuitry of the host is configured to execute a host application, thereby providing the user data; and the host application is configured to interact with a client application executing on the UE, the client application being associated with the host application.

Embodiment 50: The host of the any of the previous 2 embodiments, wherein the initiating receipt of the user data comprises requesting the user data.

Embodiment 51: A method implemented by a host configured to operate in a communication system that further includes a wireless network node and/or a repeater node and a user equipment (UE), the method comprising: at the host, initiating receipt of user data from the UE, the user data originating from a transmission which the wireless network node and/or the repeater node has received from the UE, wherein the wireless network node and/or the repeater node performs any of the steps of any of the Group B embodiments to receive the user data from the UE for the host.

Embodiment 52: The method of the previous embodiment, further comprising at the wireless network node and/or the repeater node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
BPL Beam Pair Link
CE Control Element
CPU Central Processing Unit.
CSI Channel State Information
DCI Downlink Channel Information
DL Downlink
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
FR Frequency Range
gNB New Radio Base Station
gNB-DU New Radio Base Station Distributed Unit
HSS Home Subscriber Server
IoT Internet of Things
IP Internet Protocol
LTE Long Term Evolution
MAC Medium Access Control
MME Mobility Management Entity
MTC Machine Type Communication
NCR
Network Controlled Repeater
Network Exposure Function
NEF
NF
Network Function
NR New Radio
NRF Network Function Repository Function
NSSF Network Slice Selection Function
OTT Over-the-Top
PC Personal Computer
PCF Policy Control Function
P-GW
Packet Data Network Gateway
Quality of Service
QoS
RAM Random Access Memory
RAN Radio Access Network
ROM Read Only Memory
RRC Radio Resource Control
RRH Remote Radio Head
RS Reference Signal
RSRP Reference Signal Received Power
RTT Round Trip Time
RX
Reception
Service Capability Exposure Function
SCEF
SID Study Item Description
SMF Session Management Function
SSB Synchronization Signal Block
TRP Transmission Reception Point
TX Transmission
UDM Unified Data Management
UE User Equipment
UL Uplink
UPF User Planc Function

Those skilled in the art will recognize improvements and modifications to the embodiments of the present disclosure. All such improvements and modifications are considered within the scope of the concepts disclosed herein.

1. A method performed by a wireless network node for monitoring a connection to a User Equipment, UE, through a repeater node, the method comprising:
configuring the UE and/or the repeater node with one or more beam reports containing reference signals for evaluating one or more links between one or more of the group consisting of: the wireless network node, the repeater node, and the UE;
triggering one or more of the configured beam reports;
transmitting one or more configured reference signals associated with the triggered beam reports; and
receiving the one or more beam reports.

2. The method of claim 1, wherein configuring the UE and/or the repeater node with the one or more beam reports comprises one or more of:
configuring the repeater node with one or more beam reports containing a set of X beam pair links between the wireless network node and the repeater node for evaluating the one or more beam pairs between the wireless network node, and the repeater node;
configuring the UE with a UE-only beam report containing Y reference signals to be used for evaluating Y repeater beams between the repeater node and the UE; and
configuring the UE with a joint-repeater-UE beam report containing X+Y reference signals to be used for evaluating X wireless network node beams for a service link and Y repeater beams for an access link.

3. The method of claim 1, further comprising:
monitoring radio link performance and determining where potential beam link failure has taken place.

4. The method of claim 1, wherein configuring the beam report comprises one or more of:
configuring the repeater node with a Repeater-only beam report containing X reference signals to be used for evaluating X wireless network node beams for the service link;
configuring the UE with the UE-only beam report containing Y reference signals to be used for evaluating Y repeater beams for the repeater-UE link; and
configuring the UE with the Joint-repeater-UE beam report containing X+Y reference signals to be used for evaluating X wireless network node beams for the service link and Y repeater beams for the access link.

5. The method of claim 1, wherein configuring the UE-only beam report comprises one or more of:
providing the repeater node with an associated beam mapping configuration; and
providing the repeater node with a configuration on operation modes.

6. The method of claim 1, wherein configuring the Joint-repeater-UE beam reporting comprises one or more of:
providing the repeater node with the associated beam mapping configuration; and
providing the repeater node with the configuration on operation modes.

7. The method of claim 5, wherein the operation modes comprise one or more of the group consisting of: forwarding; ON/OFF; and DL/UL.

8. The method of claim 1, wherein triggering the one or more configured beam reports is based on a determination of a failed/deteriorated connection between the wireless network node and UE served through the repeater node.

9. The method of claim 3 , wherein determining the failed/deteriorated connection between the wireless network node and the UE is based on received signal quality from Uplink, UL, signals transmitted from the repeater node to the wireless network node or based on Channel State Information, CSI, reports from the UE.

10. The method of claim 3, wherein determining the failed/deteriorated connection between the wireless network node and the UE is based on simultaneous detection of a performance drop for several UE connections served through the repeater node.

11. The method of claim 3, wherein determining the failed/deteriorated connection between the wireless network node and the UE is based on a beam failure recovery request signaled from the repeater node to the wireless network node.

12. The method of claim 3, wherein determining the failed/deteriorated connection between the wireless network node and the UE is based on simultaneously detecting the performance drop for the UE served by the wireless network node, while at the same time not detecting the performance drop for other UEs served through the repeater node.

13. The method of claim 3, wherein determining the failed/deteriorated connection between the wireless network node and the UE is based on poor UL link quality from the UE.

14. The method of claim 3, wherein determining the failed/deteriorated connection between the wireless network node and the UE is based on a beam failure recovery request signaled from the UE.

15. The method of claim 1, wherein triggering the Repeater-only beam report in case the failed/deteriorated connection between the wireless network node and the UE is determined to be a result of a failed/deteriorated service link.

16. The method of claim 1, wherein triggering the UE-only beam report in case the failed/deteriorated connection between the wireless network node and the UE is determined to be a result of a failed/deteriorated access link.

17. The method of claim 1, wherein triggering the Repeater-only beam report in case a simultaneously failed/deteriorated connection between the wireless network node and the several UEs is determined to be the result of the failed/deteriorated service link.

18. The method of claim 1, wherein triggering both the Repeater-only beam report and the UE-only beam report in case it is uncertain if the failed/deteriorated connection between the wireless network node and the UE is the result of the failed/deteriorated access link or the failed/deteriorated service link.

19. The method of claim 1, wherein triggering the Joint-repeater-UE beam report in case it is uncertain if the failed/deteriorated connection between the wireless network node and the UE is the result of the failed/deteriorated access link or the failed/deteriorated service link.

20-24. (canceled)

25. A wireless network node for monitoring a connection to a User Equipment, UE, through a repeater node, the wireless network node comprising processing circuitry and memory, the memory comprising instructions to cause the wireless network node to:
configure the UE and/or the repeater node with one or more beam reports containing reference signals for evaluating one or more links between one or more of the group consisting of: the wireless network node, the repeater node, and the UE;
trigger one or more of the configured beam reports;
transmit one or more configured reference signals associated with the triggered beam reports; and
receive the one or more beam reports.

26. (canceled)
